(19) United States
(12) Patent Application Publication
(10) Pub. No.: US 2024/0140834 A1
(43) Pub. Date: May 2, 2024

(54) DUAL FAUCET WITH STERILE WATER AND REGULAR WATER SUPPLY FUNCTION

(71) Applicant: CEBIEN CO., LTD., Gyeonggi-do (KR)

(72) Inventors: IN SHIK RYU, Gyeonggi-do (KR); BYEONG SEOL GO, Gyeonggi-do (KR); BAE DONG JHIN, Gyeonggi-do (KR)

(21) Appl. No.: 18/381,729

(22) Filed: Oct. 19, 2023

(30) Foreign Application Priority Data
Oct. 27, 2022 (KR) 10-2022-0140470

(51) Int. Cl. C02F 1/461; C02F 1/467

(52) U.S. Cl. CPC C02F 1/4618; C02F 1/4674; C02F 2201/46135; C02F 2201/4614; C02F 2307/06

(57) ABSTRACT

A dual faucet with a sterile water and general water supply function includes a faucet body including a body portion, a sterile water outlet faucet connected to the body portion and through which sterile water comes, and a regular water outlet faucet connected to the body portion near the sterile water outlet faucet and through which raw water supplied from a raw water pipe line comes, and a sterile water supply unit including a casing, and an electrolytic bath module disposed in the casing and configured to produce sterile water by electrolysis of the raw water supplied from the raw water pipe line and supply the produced sterile water to the sterile water outlet faucet, wherein the operation of the electrolytic bath module is controlled to adjust an ion concentration of the sterile water according to a measured internal voltage value or a measured internal current value.

### CROSS REFERENCE TO RELATED APPLICATIONS AND CLAIM OF PRIORITY

This application claims the benefit under 35 USC § 119 of Korean Patent Applications No. 10-2022-0140470, filed on Oct. 27, 2022, in the Korean Intellectual Property Office, the entire disclosure of which is incorporated herein by reference for all purposes.

### BACKGROUND

### 1. Field

The present disclosure relates to a dual faucet with a sterile water and regular water supply function.

### 2. Description of the Related Art

A faucet is a device designed to allow users to control the amount of water coming from an outlet, and is installed in not only sinks or basins in homes but also basins in outdoor public restrooms. The faucet is used to turn on and off water, and control the amount of water coming from an outlet or the supply of hot water and cold water by lever manipulation.

Meanwhile, in modern times, people live in densely populated areas and eat in groups and dine out frequently, and with the development of transportation, large-scale population movements take place. Accordingly, infectious disease outbreaks occur frequently and tend to occur over a wide area, and in this circumstance, the importance of hygiene cannot be emphasized enough.

To maintain good hygiene, it is necessary to remove harmful germs on users' hands, food materials such as vegetables, fruits and fish, tableware or basins installed in restrooms or bathrooms, and in some situations, when there is no detergent in sinks or basins, washing is often performed with water only, so it is difficult to maintain effective hygiene.

Additionally, washing using synthetic detergents cause secondary water pollution, and unless detergent residues on vegetables or fruits are removed by sufficiently rinsing, synthetic detergents may be absorbed into human body, causing health problems.

Accordingly, there is a need for faucets having a sterile water outlet function to achieve effective washing even when there is no detergent in sinks or basins.

### SUMMARY

The present disclosure is designed in the above-described background and therefore the present disclosure is directed to providing a dual faucet capable of supplying both sterile water and regular water from a single faucet.

The present disclosure is further directed to providing a faucet capable of automatically adjusting the ion concentration of sterile water produced by an electrolytic bath module according to a measured voltage value or a measured current value.

The objectives of the present disclosure are not limited thereto, and these and other objectives will be clearly understood by those skilled in the art from the following description.

To achieve the above-described objective, an embodiment of the present disclosure provides a dual faucet with a sterile water and general water supply function, including a faucet body including a body portion, a sterile water outlet faucet connected to the body portion and through which sterile water comes, and a regular water outlet faucet connected to the body portion near the sterile water outlet faucet and through which raw water supplied from a raw water pipe line comes; and a sterile water supply unit including a casing, and an electrolytic bath module disposed in the casing and configured to produce sterile water by electrolysis of the raw water supplied from the raw water pipe line and supply the produced sterile water to the sterile water outlet faucet, wherein the operation of the electrolytic bath module is controlled to adjust an ion concentration of the sterile water according to a measured internal voltage value or a measured internal current value.

Additionally, there is provided the dual faucet with the sterile water and general water supply function wherein the operation of the electrolytic bath module is controlled to constantly maintain the measured voltage value at a preset reference voltage value according to a corresponding voltage value for each ion concentration of the sterile water, or wherein the operation of the electrolytic bath module is controlled to constantly maintain the measured current value at a preset reference current value according to a corresponding current value for each ion concentration of the sterile water.

Additionally, there is provided the dual faucet with the sterile water and general water supply function wherein the electrolytic bath module is controlled to be powered on or off to maintain the measured voltage value at the reference voltage value or the measured current value at the reference current value.

Additionally, there is provided the dual faucet with the sterile water and general water supply function further including an operation switch configured to generate a switching signal for controlling the electrolytic bath module by external manipulation, wherein the electrolytic bath module is controlled to be powered on or off by the switching signal.

Additionally, there is provided the dual faucet with the sterile water and general water supply function wherein the operation of the electrolytic bath module is controlled according to the measured voltage value or the measured current value after the electrolytic bath module is powered on by the switching signal.

According to an embodiment of the present disclosure, it may be possible to supply both sterile water and regular water from a single faucet.

Additionally, it may be possible to automatically adjust the ion concentration of sterile water produced by the electrolytic bath module according to the measured voltage value or the measured current value.

### BRIEF DESCRIPTION OF THE DRAWINGS

FIG. 1 is a diagram showing an entire configuration of a faucet according to an embodiment of the present disclosure.

FIG. 2 is a diagram showing a detailed configuration of a faucet body according to an embodiment of the present disclosure.

FIG. 3 is a diagram showing a detailed configuration of a faucet body according to an embodiment of the present disclosure.

FIG. 4 is a diagram showing a detailed configuration of a faucet body according to an embodiment of the present disclosure.

FIG. 5 is an exploded diagram showing an entire configuration of a sterile water supply unit according to an embodiment of the present disclosure.

FIG. 6 is a diagram showing a detailed internal configuration of a sterile water supply unit according to an embodiment of the present disclosure.

FIG. 7 is a diagram showing a connection structure of a faucet body and an electrolytic bath module according to an embodiment of the present disclosure.

FIG. 8 is a diagram showing a detailed configuration of an electrolytic bath module according to an embodiment of the present disclosure.

FIG. 9 is a block diagram showing a control module of a faucet according to an embodiment of the present disclosure and operation control by the control module.

FIG. 10 is a diagram showing a process of controlling each component based on each operational condition of a faucet according to an embodiment of the present disclosure.

FIG. 11 is a flowchart showing a process of controlling an electrolytic bath module of a faucet according to an embodiment of the present disclosure.

### DETAILED DESCRIPTION

Hereinafter, some embodiments of the present disclosure will be described in detail through the exemplary drawings. In affixing the reference signs to the elements of each drawing, it should be noted that the identical elements have the identical signs as possible although they are shown in different drawings. Additionally, in describing the present disclosure, when it is determined that a certain detailed description of relevant known features or functions may obscure the subject matter of the present disclosure, the detailed description is omitted.

Additionally, in describing the elements of the present disclosure, the terms “first”, “second”, A, B, (a), (b) or the like may be used. These terms are used to distinguish one element from another, and the nature, sequence or order of the corresponding elements are not limited by the terms. When an element is referred to as being “connected to”, “coupled to” or “joined to” another element, the element may be directly connected or joined to the other element, but it should be understood that intervening elements may be “connected”, “coupled” or “joined” between each element.

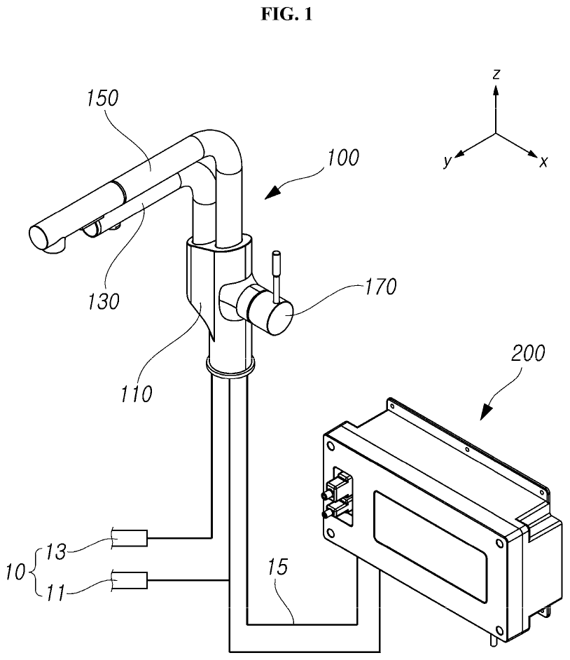

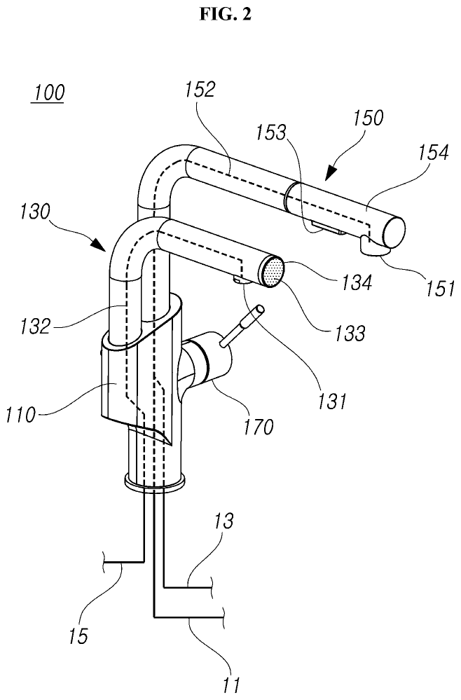

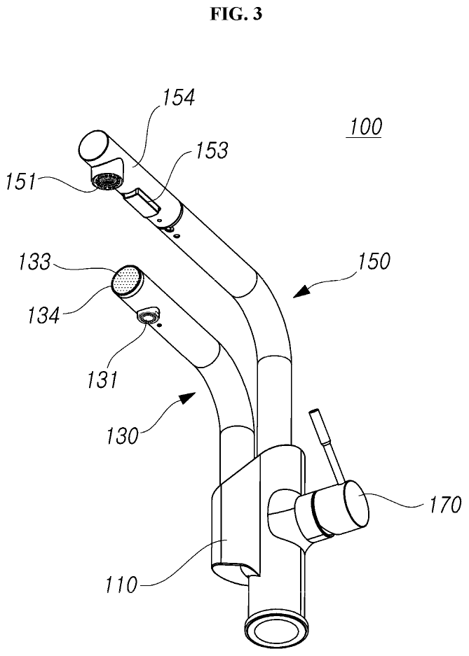

Hereinafter, each component of the present disclosure will be described in detail with reference to FIGS. 1 to 11.

There is provided a dual faucet with a sterile water and regular water supply function according to an embodiment of the present disclosure, and as shown in FIG. 1, the faucet according to an embodiment of the present disclosure may include a faucet body 100 configured to dispense sterile water and regular water, and a sterile water supply unit 200 configured to supply sterile water to the faucet body 100.

First, each component of the faucet body 100 of the faucet according to an embodiment of the present disclosure will be described with reference to FIGS. 1 to 4.

The faucet body 100 according to an embodiment of the present disclosure may include a body portion 110, a sterile water outlet faucet 130 connected to the body portion 110 and through which sterile water comes, and a regular water outlet faucet 150 connected to the body portion 110 near the sterile water outlet faucet 130 and through which raw water supplied from a raw water pipe line 10 comes.

The faucet body 100 according to an embodiment of the present disclosure is characterized in having a dual structure including the sterile water outlet faucet 130 through which sterile water comes and the regular water outlet faucet 150 through which regular water comes, and the faucet body 100 may be installed in a sink and connected to the raw water pipe line 10 to receive raw water.

Here, the raw water pipe line 10 supplying raw water may include a cold water pipe line 11 to supply cold raw water and a hot water pipe line 13 to supply hot raw water as shown in FIG. 1.

The body portion 110 may be the component having a hollow inner hole along the lengthwise direction. The sterile water outlet faucet 130 and the regular water outlet faucet 150 as described below may be connected to the top of the body portion 110, and a regular water manipulation unit 170 as described below may be disposed on the side of the body portion 110.

The sterile water outlet faucet 130 may be, for example, formed in the shape of “¬” such that a part of the sterile water outlet faucet 130 is bent, and may have one end connected to the body portion 110 and a sterile water outlet 131 at the other end, through which sterile water supplied from an electrolytic bath module 210 as described below comes.

The sterile water outlet faucet 130 may include a sterile water channel 132 inside to allow sterile water supplied from the electrolytic bath module 210 to flow, and in this instance, the sterile water channel 132 may be, for example, formed by a hose shaped component.

The sterile water channel 132 with one end connected to the sterile water outlet 131 may extend along the sterile water outlet faucet 130 and the body portion 110 with the other end connected to a sterile water supply line 15 connected to the electrolytic bath module 210, to allow sterile water produced by the electrolytic bath module 210 to flow in the sterile water supply line 15 and the sterile water channel 132 and come out of the sterile water outlet 131.

Meanwhile, the sterile water outlet faucet 130 may include an operation switch 133 to control the flow of sterile water from the sterile water outlet faucet 130.

The operation switch 133 may be disposed at the end of the sterile water outlet faucet 130, and may be in the form of an electronic touch switch to generate a switching signal for changing the operational condition of the electrolytic bath module 210 and a control valve 250 as described below by a user's touch.

Meanwhile, the sterile water outlet faucet 130 may include a light emitting unit 134 and a speaker unit 135 to display or notify the operational condition of the sterile water outlet faucet 130.

The light emitting unit 134 may be disposed at the end of the sterile water outlet faucet 130 together with the operation switch 133, and for example, may be a light-emitting diode (LED) light source. The light emitting unit 134 may be configured to emit light of different colors depending on the operational condition of the sterile water outlet faucet 130.

Meanwhile, the speaker unit 135 may be disposed in the body portion 110 or the sterile water outlet faucet 130, and may be configured to emit different notification sounds depending on the operational condition of the sterile water outlet faucet 130.

As the sterile water outlet faucet 130 includes the light emitting unit 134 and the speaker unit 135 to display or notify the operational condition of the sterile water outlet faucet 130, the user may easily identify the operational condition of the sterile water outlet faucet 130 by the light emitting unit 134 and the speaker unit 135.

Subsequently, in the same way as the sterile water outlet faucet 130, the regular water outlet faucet 150 may be, for example, formed in the shape of “¬” such that a part of the regular water outlet faucet 150 is bent, and may have one end connected to the body portion 110 near the sterile water outlet faucet 130 and a regular water outlet 151 at the other end, through which raw water supplied from the raw water pipe line 10 comes.

The regular water outlet faucet 150 may include a regular water channel 152 inside to allow raw water supplied from the raw water pipe line 10 to flow, and in this instance, the regular water channel 152 may be, for example, formed by a hose shaped component.

The regular water channel 152 with one end connected to the regular water outlet 151 may extend along the regular water outlet faucet 150 and the body portion 110 with the other end connected to the cold water pipe line 11 and the hot water pipe line 13 of the raw water pipe line 10, to allow cold raw water and hot raw water supplied from the cold water pipe line 11 and the hot water pipe line 13 to flow in the regular water channel 152 and come as regular water through the regular water outlet 151 (raw water coming through a regular water outlet faucet is hereinafter referred to as regular water).

Meanwhile, the regular water outlet faucet 150 may include a water outlet control button 153 to control the regular water outlet type.

The water outlet control button 153 may be disposed at the end of the regular water outlet faucet 150, and may control regular water to come out of the regular water outlet faucet 150 in the form of bubble or spray by the user's manipulation.

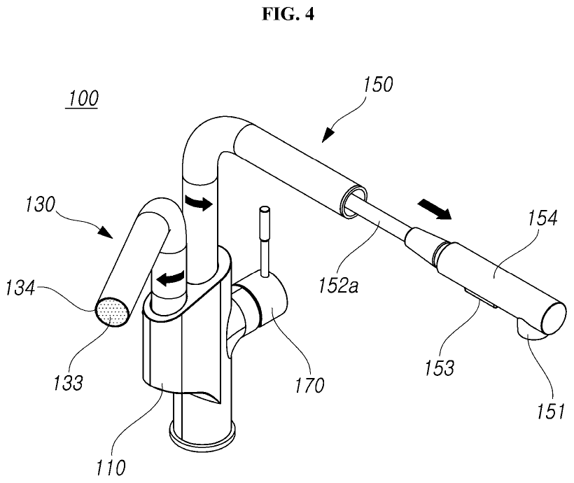

Here, as shown in FIG. 4, the regular water outlet faucet 150 may include a separable head 154 separably formed from the end of the regular water outlet faucet 150, including the regular water outlet 151.

The separable head 154 may include the regular water outlet 151 and may be separated from the end of the regular water outlet faucet 150 or coupled to the end of the regular water outlet faucet 150 again to allow the user to separate and use the separable head 154 from the end of the regular water outlet faucet 150 when necessary.

In this instance, as described above, the regular water channel 152 connected to the regular water outlet 151 may be formed by the hose shaped component, and accordingly when the separable head 154 is separated from the end of the regular water outlet faucet 150, a hose 152a forming the regular water channel 152 may be taken from the regular water outlet faucet 150 together with the separable head 154.

Meanwhile, the water outlet control button 153 may be disposed in the separable head 154.

Subsequently, the faucet body 100 may include the regular water manipulation unit 170 to control the flow of regular water from the regular water outlet faucet 150.

The regular water manipulation unit 170 may be disposed on the side of the body portion 110, and may be in the form of a lever rotatably formed in the left-right direction and the up-down direction to control the regular water outlet faucet 150 to turn on and off water and dispense cold regular water and hot regular water by the user's manipulation.

For example, the regular water manipulation unit 170 may be configured to control the regular water outlet faucet 150 to turn on and off water by rotation in the left-right direction (x direction in FIG. 1), and dispense cold regular water and hot regular water by rotation in the front-rear direction (y direction in FIG. 1). Each of the sterile water outlet faucet 130 and the regular water outlet faucet 150 may be connected to the body portion 110 adjacent to each other, and as shown in FIG. 4, each of the sterile water outlet faucet 130 and the regular water outlet faucet 150 may be rotatably coupled to the body portion 110 to allow the user to rotate the sterile water outlet faucet 130 and the regular water outlet faucet 150 to change the water outlet direction of sterile water and regular water as necessary.

Subsequently, each component of the sterile water supply unit 200 of the faucet according to an embodiment of the present disclosure will be described with reference to FIGS. 1 and 5 to 10.

The sterile water supply unit 200 according to an embodiment of the present disclosure may include a casing 201, 202 having an internal accommodation space, the electrolytic bath module 210 disposed in the casing 201, 202 and configured to produce sterile water by electrolysis of raw water supplied from the raw water pipe line 10 and supply the produced sterile water to the sterile water outlet faucet 130, the control valve 250 disposed in the casing 201, 202 to shut off the raw water supply to the electrolytic bath module 210 and a control module 230 disposed in the casing 201, 202 and configured to control the operation of the electrolytic bath module 210 and the control valve 250, and the sterile water supply unit 200 according to an embodiment of the present disclosure may be installed in a space below the sink at which the faucet body 100 is installed.

The casing 201, 202 may include a first casing 201 and a second casing 202 coupled to form the internal accommodation space, and the electrolytic bath module 210, the control module 230 and the control valve 250 as described below may be accommodated in the casing 201, 202.

The electrolytic bath module 210 is disposed in the casing 201, 202, and configured to produce sterile water by electrolysis of raw water supplied from the raw water pipe line 10 and supply the produced sterile water to the sterile water outlet faucet 130.

The electrolytic bath module 210 may be installed in the space below the sink together the casing 201, 202, and may be connected to the raw water pipe line 10 to receive raw water from the raw water pipe line 10 and produce sterile water.

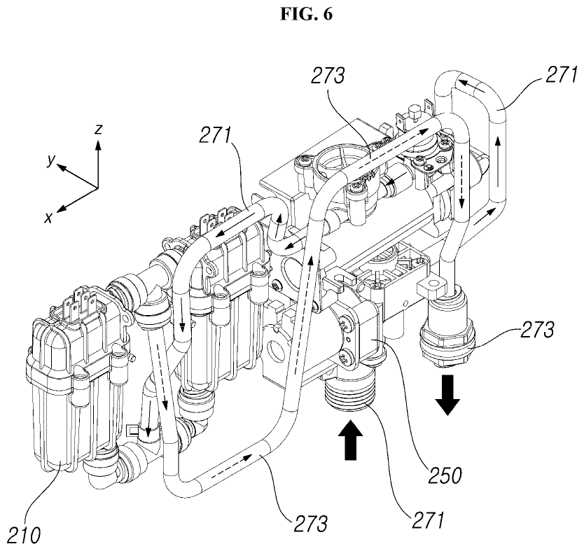

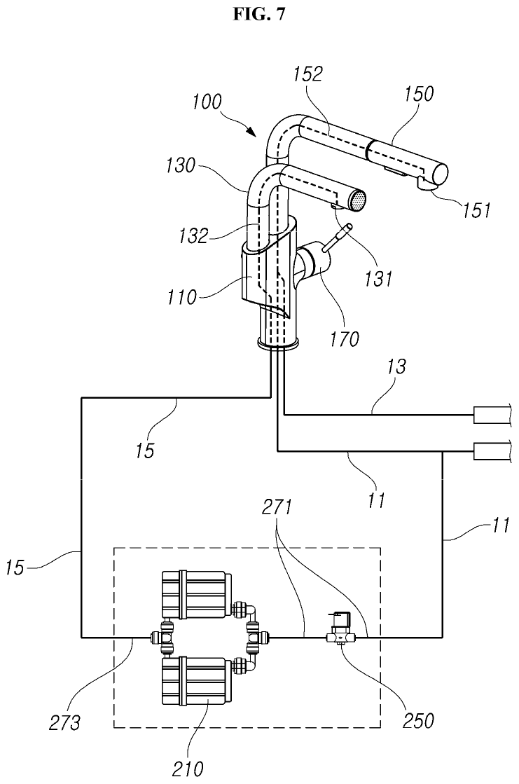

More specifically, as shown in FIGS. 6 and 7, the electrolytic bath module 210 may be connected to the cold water pipe line 11 of the raw water pipe line 10 through a regular water inlet pipe 271, and the electrolytic bath module 210 may be supplied with raw water through the regular water inlet pipe 271.

In this instance, the regular water inlet pipe 271 connecting the electrolytic bath module 210 to the cold water pipe line 11 may have the control valve 250 to shut off the raw water supply to the electrolytic bath module 210, and the control valve 250 may be, for example, a solenoid valve and may be configured to control the raw water supplied to the electrolytic bath module 210.

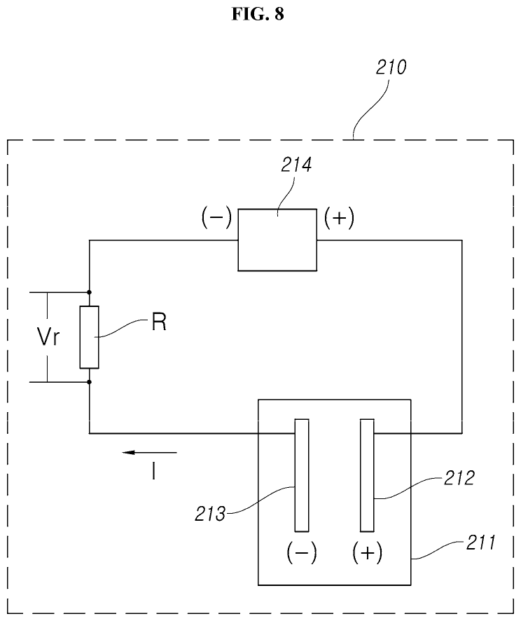

Meanwhile, as shown in FIG. 8, the electrolytic bath module 210 according to an embodiment of the present disclosure may be an electrolysis device including a housing 211 having a sterile water production space inside, a (+) electrode 212 and a (−) electrode 213 installed in the housing 211, a power supply unit 214 configured to form a potential difference between the (+) electrode 212 and the (−) electrode 213 to produce sterile water by electrolysis of raw water fed into the electrolytic bath module 210.

Here, the raw water to be electrolyzed may be tap water containing chlorine, and the sterile water produced by electrolysis may be ionized water containing hypochlorous acid (HClO) produced by the electrolysis of the tap water containing chlorine.

For example, raw water containing a predetermined concentration of chlorine is supplied to the housing 211 of the electrolytic bath module 210, followed by electrolysis using a direct current applied to the (+) electrode 212 and the (−) electrode 213 through the power supply unit 214, chlorine (Cl₂(aq)) is produced by oxidation of chloride ion (Cl⁻) dissociated in the raw water at the (+) electrode 212, and chlorine (Cl₂) reacts with the raw water to produce hypochlorous acid (HOCl).

Meanwhile, the operation of the electrolytic bath module 210 according to an embodiment of the present disclosure may be controlled by the control module 230 as described below to adjust the ion concentration of sterile water according to a measured internal voltage value Vr or a measured internal current value I that changes depending on the ion concentration of sterile water in the housing 211.

Here, as shown in FIG. 8, the measured internal voltage value Vr may refer to a voltage value under the load resistance R of the electrolytic bath module 210, and the measured internal current value I may refer to a current value calculated by the load resistance R and the measured internal voltage value Vr (I=Vr/R).

Accordingly, the electrolytic bath module 210 may include a measurement unit 215 to measure the voltage value under the load resistance R of the electrolytic bath module 210, or calculate the current value based on the measured voltage value and the load resistance R.

The sterile water produced by the electrolytic bath module 210 is in an electrolyte solution state including electrolyte ions such as chloride ion (Cl⁻), hypochlorite ion (OCl⁻), hydroxide ion (OH⁻), and as the electrolyte solution has higher ion concentration in a predetermined concentration range, the intensity of the current flowing through ions is also higher, and in this instance, when the intensity of the current flowing through ions in sterile water is higher, the voltage value under the load resistance R of the electrolytic bath module 210 is also higher (Vr=IR).

That is, the ion concentration of sterile water may be determined by measuring the voltage value under the load resistance R of the electrolytic bath module 210, and using the above-described principle, the electrolytic bath module 210 according to an embodiment of the present disclosure is configured to control the ion concentration of sterile water through the measured internal voltage value Vr or the measured internal current value I of the electrolytic bath module 210.

More specifically, the operation of the electrolytic bath module 210 may be controlled to constantly maintain the measured voltage value Vr at a preset reference voltage value according to a corresponding voltage value for each ion concentration of sterile water, or constantly maintain the measured current value I at a preset reference current value according to a corresponding current value for each ion concentration of sterile water.

Here, the corresponding voltage value for each ion concentration of sterile water may refer to voltage values under the load resistance R of the electrolytic bath module 210 corresponding to the ion concentration of sterile water, each measured for each ion concentration of sterile water, and as described above, with the increasing ion concentration of the electrolyte solution in the predetermined concentration range, the voltage value under the load resistance R of the electrolytic bath module 210 increases, and the ion concentration for sterile water for each condition and the voltage value measured for each ion concentration of sterile water may correspond to each other.

Additionally, the corresponding current value for each ion concentration of sterile water may refer to current values corresponding to the ion concentration of sterile water calculated based on the load resistance R and the corresponding voltage value for each ion concentration of sterile water.

The operation of the electrolytic bath module 210 may be controlled to constantly maintain the measured voltage value Vr at the preset reference voltage value to constantly adjust the ion concentration of sterile water, and for example, when the ion concentration of sterile water is 1000 ppm, in case where the corresponding voltage value is set to 4 V and the reference voltage value is set to 4 V, the electrolytic bath module 210 may be controlled to constantly maintain the measured voltage value Vr at 4 V to constantly maintain the ion concentration of sterile water at 1000 ppm.

Additionally, the operation of the electrolytic bath module 210 may be controlled to constantly maintain the measured current value I at the preset reference current value to constantly adjust the ion concentration of sterile water, and for example, when the ion concentration of sterile water is 1000 ppm, in case where the corresponding current is set to 2 A and the reference current value is set to 2 A, the electrolytic bath module 210 may be controlled to constantly maintain the measured current value I at 2 A to constantly maintain the ion concentration of sterile water at 1000 ppm.

Here, the electrolytic bath module 210 is controlled to be powered on or off to maintain the measured voltage value Vr at the reference voltage value or the measured current value I at the reference current value.

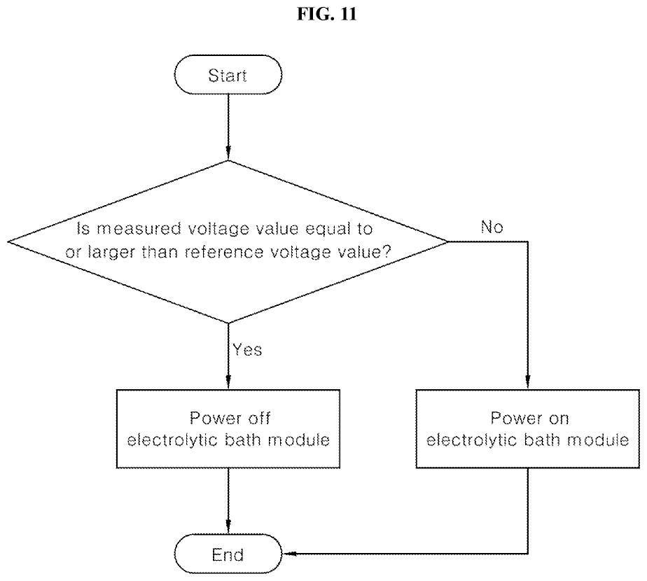

For example, as shown in FIG. 11, when the measured voltage value Vr is equal to or larger than the reference voltage value, the electrolytic bath module 210 may be controlled to be powered off, and when the measured voltage value is smaller than the reference voltage value, the electrolytic bath module 210 may be controlled to be powered on.

That is, when the measured voltage value Vr is equal to or larger than the reference voltage value, the electrolytic bath module 210 may be powered off to reduce the ion concentration of sterile water, and when the measured voltage value Vr is smaller than the reference voltage value, the electrolytic bath module 210 may be powered on to increase the ion concentration of sterile water, so the ion concentration of sterile water is kept constant.

Additionally, when the measured current value I is equal to or larger than the reference current value, the electrolytic bath module 210 may be controlled to be powered off, and when the measured current value I is smaller than the reference current value, the electrolytic bath module 210 may be controlled to be powered on.

That is, when the measured current value I is equal to or larger than the reference current value, the electrolytic bath module 210 may be powered off to reduce the ion concentration of sterile water, and when the measured current value I is smaller than the reference current value, the electrolytic bath module 210 may be powered on to increase the ion concentration of sterile water, so the ion concentration of sterile water is kept constant.

Meanwhile, as shown in FIGS. 6 and 7, the sterile water produced by the electrolytic bath module 210 flows from the electrolytic bath module 210 through a sterile water outlet pipe 273 connected, at one end, to the electrolytic bath module 210 and at the other end, to the sterile water supply line 15, and the sterile water from the electrolytic bath module 210 is supplied to the sterile water outlet faucet 130 through the sterile water supply line 15 connecting the sterile water outlet pipe 273 to the sterile water channel 132 of the sterile water outlet faucet 130.

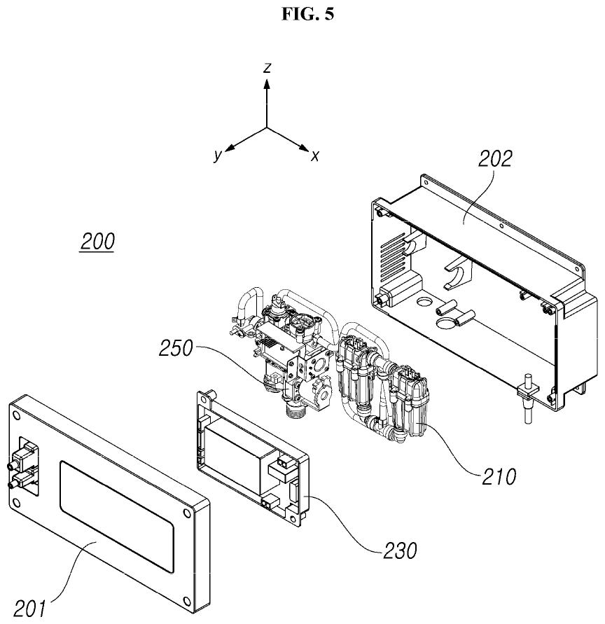

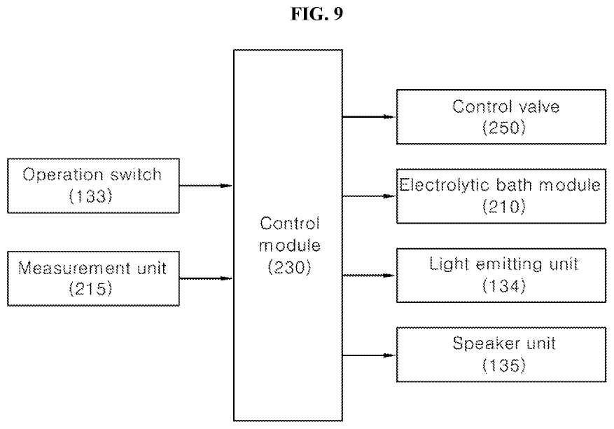

Subsequently, as shown in FIGS. 5 and 9, the control module 230 is disposed in the casing 201, 202, and configured to control the operation of the electrolytic bath module 210, the control valve 250, the light emitting unit 134 and the speaker unit 135.

More specifically, the control module 230 may be configured to receive the switching signal generated by the operation switch 133 and control the operation of the electrolytic bath module 210, the control valve 250, the light emitting unit 134 and the speaker unit 135 in response to the received switching signal, and to receive the measured voltage value Vr or the measured current value I from the measurement unit 215 of the electrolytic bath module 210 and control the operation of the electrolytic bath module 210 according to the received measured voltage value Vr or measured current value I.

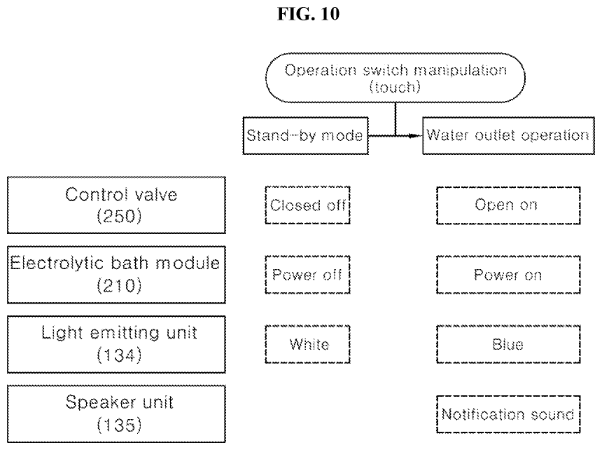

Here, as shown in FIG. 10, the operational condition of the faucet according to an embodiment of the present disclosure may be changed to initial condition “stand-by mode” and “water outlet operation” by the user's manipulation of the operation switch 133, and the control module 230 is configured to control the operation of each of the electrolytic bath module 210, the control valve 250, the light emitting unit 134 and the speaker unit 135 based on each operational condition.

More specifically, in the stand-by mode, the control module 230 may control to close the control valve 250 and power off the electrolytic bath module 210, and control the light emitting unit 134 to emit light of a preset color (for example, white).

The stand-by mode is a mode in which the user does not use sterile water, and the control valve 250 is controlled to be closed, and sterile water does not come through the sterile water outlet faucet 130.

Subsequently, in the stand-by mode, when the user manipulates the operation switch 133 (for example, the user touches the switch), the control module 230 receives the switching signal from the operation switch 133 and changes the operational condition of the faucet to the water outlet operation mode, and specifically, when the control module 230 receives the switching signal, the control module 230 controls to open the control valve 250 and power on the electrolytic bath module 210.

Accordingly, in the water outlet operation mode, sterile water produced by the electrolytic bath module 210 is supplied to the sterile water outlet faucet 130 and sterile water comes out of the sterile water outlet faucet 130.

Here, after the electrolytic bath module 210 is powered on in response to the switching signal, the operation may be controlled according to the measured voltage value Vr or the measured current value I as described above.

That is, after the control module 230 powers on the electrolytic bath module 210 in response to the switching signal, the control module 230 is configured to control the operation of the electrolytic bath module 210 according to the measured voltage value Vr or the measured current value I received from the measurement unit 215 of the electrolytic bath module 210.

More specifically, as shown in FIG. 11, the control module 230 may power on or off the electrolytic bath module 210 to constantly maintain the measured voltage value Vr received from the measurement unit 215 at the preset reference voltage value, and for example, when the measured voltage value Vr received from the measurement unit 215 is equal to or larger than the reference voltage value, the control module 230 may control the operation of the electrolytic bath module 210 to power off the electrolytic bath module 210, and when the measured voltage value Vr is smaller than the reference voltage value, the control module 230 may control the operation of the electrolytic bath module 210 to power on the electrolytic bath module 210.

Additionally, the control module 230 may power on or off the electrolytic bath module 210 to constantly maintain the measured current value I received from the measurement unit 215 at the preset reference current value, and for example, when the measured current value I received from the measurement unit 215 is equal to or larger than the reference current value, the control module 230 may control the operation of the electrolytic bath module 210 to power off the electrolytic bath module 210, and when the measured current value I is smaller than the reference current value, the control module 230 may control the operation of the electrolytic bath module 210 to power on the electrolytic bath module 210.

Meanwhile, in the water outlet operation mode, the control module 230 may control the light emitting unit 134 to emit light of a preset color (for example, blue) that is different from the color in the stand-by mode, and control the speaker unit 135 to emit a preset notification sound (for example, “safety washing will start”).

As described above, the faucet according to an embodiment of the present disclosure may be configured to change the operational condition to the stand-by mode in which sterile water does not come out of the faucet and the water outlet operation mode in which sterile water comes out of the faucet by the user's manipulation of the operation switch 133.

The dual faucet with the sterile water and regular water supply function according to the present disclosure as described hereinabove may be installed in kitchen sinks as well as basins in restrooms in houses or public restrooms and bathrooms in houses.

Although it has been hereinabove described that all the elements according to an embodiment of the present disclosure are combined into one or work in combination, the present disclosure is not necessarily limited to this embodiment. That is, all the elements may be selectively combined into at least one and work in combination within the intended scope of the present disclosure.

Although the foregoing description describes the technical spirit of the present disclosure by way of illustration, it is obvious to those having ordinary skill in the technical field pertaining to the present disclosure that a variety of modifications and changes may be made thereto without departing from the essential features of the present disclosure. Accordingly, the disclosed embodiments are provided to describe the technical spirit of the present disclosure, but not intended as limiting, and the scope of technical spirit of the present disclosure is not limited by these embodiments. The scope of protection of the present disclosure should be interpreted by the appended claims, and it should be construed that all the technical spirit within the equivalent scope falls within the scope of protection of the present disclosure.

What is claimed is:

1. A dual faucet with a sterile water and general water supply function, comprising:
a faucet body including a body portion, a sterile water outlet faucet connected to the body portion and through which sterile water comes, and a regular water outlet faucet connected to the body portion near the sterile water outlet faucet and through which raw water supplied from a raw water pipe line comes; and
a sterile water supply unit including a casing, and an electrolytic bath module disposed in the casing and configured to produce sterile water by electrolysis of the raw water supplied from the raw water pipe line and supply the produced sterile water to the sterile water outlet faucet,
wherein the operation of the electrolytic bath module is controlled to adjust an ion concentration of the sterile water according to a measured internal voltage value or a measured internal current value.

2. The dual faucet with the sterile water and general water supply function according to claim 1, wherein the operation of the electrolytic bath module is controlled to constantly maintain the measured voltage value at a preset reference voltage value according to a corresponding voltage value for each ion concentration of the sterile water, or
wherein the operation of the electrolytic bath module is controlled to constantly maintain the measured current value at a preset reference current value according to a corresponding current value for each ion concentration of the sterile water.

3. The dual faucet with the sterile water and general water supply function according to claim 2, wherein the electrolytic bath module is controlled to be powered on or off to maintain the measured voltage value at the reference voltage value or the measured current value at the reference current value.

4. The dual faucet with the sterile water and general water supply function according to claim 1, further comprising:
an operation switch configured to generate a switching signal for controlling the electrolytic bath module by external manipulation,
wherein the electrolytic bath module is controlled to be powered on or off by the switching signal.

5. The dual faucet with the sterile water and general water supply function according to claim 4, wherein the operation of the electrolytic bath module is controlled according to the measured voltage value or the measured current value after the electrolytic bath module is powered on by the switching signal.
